(19) United States
(12) Patent Application Publication
(10) Pub. No.: US 2016/0149385 A1
(43) Pub. Date: May 26, 2016

(54) ELECTRIC WIRE PROTECTION MEMBER

(71) Applicant: Yazaki Corporation, Tokyo (JP)

(72) Inventor: Masataka YAMAMOTO, Makinohara-shi (JP)

(73) Assignee: Yazaki Corporation, Tokyo (JP)

(21) Appl. No.: 14/948,787

(22) Filed: Nov. 23, 2015

(30) Foreign Application Priority Data
Nov. 25, 2014 (JP) 2014-238067

(51) Int. Cl. H02G 3/06; B60R 16/02; H02G 3/04

(52) U.S. Cl. CPC H02G 3/06; H02G 3/0462; H02G 3/0481; B60R 16/0215; H02G 3/0468

(57) ABSTRACT

An electric wire protection member includes: a cylindrical electric wire protection tube which has flexibility; a cylindrical coating member which is molded on an outer circumference surface of the electric wire protection tube; and a locking fixture which is integrally molded with the cylindrical coating member and locked to an attachment hole of a vehicle body panel. At least one rib is formed in a side surface of the cylindrical coating member to protrude from the side surface and to extend continuously in a direction along an axis of the cylindrical coating member.

### CROSS REFERENCE TO RELATED APPLICATION(S)

This application is based on and claims priority from Japanese Patent Application (Application No. 2014-238067) filed on Nov. 25, 2014, the entire contents of which are incorporated herein by reference.

### BACKGROUND

1. Field of the Invention

One or more embodiments of the present invention relate to an electric wire protection member.

2. Description of the Related Art

A protection tube for preventing electric wires from being damaged due to their contact with another member is used for a wire harness provided in a car etc. A locking fixture to be locked to an attachment hole of a vehicle body panel where the electric wires should be arranged is bound tightly to an outer circumference of the protection tube. The protection tube is made of a synthetic resin material to be flexible. However, the protection tube may be destroyed at the place to which the locking fixture is bound tightly with a binding band etc. The electric wires may be bitten at the destroyed place of the protection tube. In addition, in the destroyed place, there arises a problem that an electric wire reception space may be reduced to lower the electric wire protection function.

To solve the problem, there has been proposed a locking fixture-including protection tube (electric wire protection member) in which a locking fixture is integrally molded with a protection tube so that the locking fixture can be locked to an attachment hole of a vehicle body panel (see JP-A-2012-217295). As shown in FIG. 10, a wire harness 501 has a locking fixture-including protection tube 503. In the locking fixture-including protection tube 503, a locking fixture 507 to be locked to an attachment hole of a vehicle body panel where electric wires 505 should be arranged is provided on an outer circumferential surface of a protection tube (electric wire protection tube) 511. The protection tube 511 is formed into a cylindrical shape to receive an electric wire bundle 509 therein.

In the locking fixture-including protection tube 503, a cylindrical portion 513 serving as a cylindrical coating member formed into a circular cylindrical shape is provided on the outer circumferential surface of the protection tube 511. The protection tube 511 made of a synthetic resin includes a plurality of large diameter portions 515 and a plurality of small diameter portions 517 which are provided consecutively and alternately. With the configuration, the protection tube 511 has flexibility (easy bendability). An outer circumferential groove 519 is formed as a recess between every two of the large diameter portions adjacent to each other across the small diameter portion 517. The outer circumferential groove 519 is filled with an internal molding portion. In this manner, the cylindrical portion 513 provided on the outer circumferential surface of the protection tube 511 can be integrated with the protection tube 511. In the locking fixture 507 provided on the cylindrical portion 513, a pair of lock claws 521 are narrowed so that an axial portion 523 can be inserted into the attachment hole of the vehicle body panel. As soon as an abutment plate 525 abuts against the vehicle body panel, the pair of locking crawls 521 are opened on a back side of the vehicle body panel so that the vehicle body panel can be held between the locking crawls 521 and the abutment plate 525. Thus, the locking fixture 507 is locked to the vehicle body panel.

According to the locking fixture-including protection tube 503, the locking fixture 507 is integrally molded with the protection tube 511. Accordingly, it is not necessary to tightly bind the locking fixture to the protection tube with a binding band as described above. Therefore, the protection tube 511 can be prevented from being destroyed due to tight binding with the binding band.

### SUMMARY

However, the locking fixture-including protection tube 503 according to the background art may generate the following problem. That is, when the cylindrical portion 513 is integrally molded with the outer circumferential surface of the protection tube 511, the plurality of large diameter portions 515 and the plurality of small diameter portions 517 which are provided consecutively and alternately exhibit resistance to the flow of a resin to thereby hinder the resin from flowing up to a terminal end of the cylindrical portion (cylindrical coating member) 513 or the locking fixture 507. On the other hand, when the thickness of the cylindrical portion 513 is increased in order to improve the flow of the resin, the weight of the locking fixture-including protection tube 503 increases and the amount of the resin increases wastefully. In addition, the fact that the resin does not flow sufficiently may be another factor causing separation between the protection tube 511 and the cylindrical portion 513.

One or more embodiments of the invention have been made in consideration of the above-described circumstances, and an object thereof is to provide an electric wire protection member in which a resin can be made to flow easily up to a terminal end during molding.

The above-described object according to one or more embodiments of the invention can be achieved by the following configurations.

(1) An electric wire protection member including: a cylindrical electric wire protection tube which has flexibility; a cylindrical coating member which is molded on an outer circumference surface of the electric wire protection tube; and a locking fixture which is integrally molded with the cylindrical coating member and locked to an attachment hole of a vehicle body panel; wherein: at least one rib is formed in a side surface of the cylindrical coating member to protrude from the side surface and to extend continuously in a direction along an axis of the cylindrical coating member.

According to the electric wire protection member having the configuration (1), the rib extends continuously along the axis of the cylindrical coating member and protrudes from the side surface thereof. The cylindrical coating member and the locking fixture are molded by injecting a resin into a cavity of a mold. On this occasion, the electric wire protection tube is placed in the cavity. That is, the cylindrical coating member is molded out of the resin which flows into a gap between the electric wire protection tube and the cavity. The gap forms the thickness of the cylindrical coating member. When a thin molded article is molded, the flow of the resin during injection is hindered by the gap which is narrow and long or by irregularities of the electric wire protection tube. Accordingly, the resin can hardly flow up to a terminal end of the molded article. On the other hand, the electric wire protection member having the configuration (1) includes the rib provided in the side surface of the cylindrical coating member. Thus, a groove in a direction thickening the gap is formed in an inner wall surface of the cavity corresponding to a portion where the rib should be molded. The groove is a passage in which the injected resin can flow satisfactorily. The resin flowing in the groove reaches opposite axial ends of the cylindrical coating member immediately. In this state, the resin can reach the terminal end of the molded article from the groove through the gap of a short circumferential distance easily.

(2) The electric wire protection member according to the configuration (1), wherein a plurality of ribs are provided at circumferentially different positions in the cylindrical coating member.

According to the electric wire protection member having the configuration (2), the plurality of ribs are provided. Accordingly, restriction of a bending direction of the cylindrical coating member can be controlled. When, for example, three ribs are disposed at equal intervals on an outer circumference of the cylindrical coating member which is shaped like a circular cylinder, bending or vibration of the cylindrical coating member in all directions can be restricted equally. In addition, when, for example, two ribs are disposed at equal intervals on the outer circumference of the cylindrical coating member which is shaped like a circular cylinder, bending or vibration of the cylindrical coating member in an in-plane direction including the pair of ribs can be restricted.

(3) The electric wire protection member according to the configuration (1) or (2), wherein the electric wire protection tube includes a plurality of large diameter portions and a plurality of small diameter portions provided consecutively and alternately such that an outer circumferential groove is formed as a recess between every two of the large diameter portions adjacent to each other across the small diameter portion, and wherein the cylindrical coating member includes a plurality of annular portions which are molded on at least a part of the outer circumferential grooves in an outer circumferential direction and which are connected by the rib.

According to the electric wire protection member having the configuration (3), the plurality of annular portions are molded and firmly fixed to the outer circumferential grooves of the electric wire protection tube. While circumferential parts of the annular portions are connected by the ribs, the annular portions are mostly separated from one another in the circumferential direction. Thus, a usage amount of the resin can be reduced.

(4) The electric wire protection member according to any one of the configurations (1) to (3), wherein the cylindrical coating member includes a thick portion and a flat or gently curved face, wherein the thick portion is molded to be radially thicker than, of any other circumferential portion of the cylindrical coating member, at least an outer circumferential portion where the locking fixture is provided to protrude, and wherein the flat or gently curved face is formed in an outer surface of the thick portion to be substantially parallel with a plane passing through an axis of the electric wire protection tube.

According to the electric wire protection member having the configuration (4), the thick portion serves as a bearing wall so that the cylindrical coating member provided with the thick portion can be prevented from being easily destroyed in the radial direction. In addition, only the thick portion provided in the cylindrical coating member protrudes from the outer circumferential surface of the cylindrical coating member more than any other outer circumferential portion. Therefore, enlargement of the cylindrical coating member can be suppressed in comparison with the case where the cylindrical coating member is made thick all over the circumference thereof. Further, the flat face or the gently curved face substantially parallel with the plane passing through the axis of the electric wire protection tube is formed in the outer surface of the thick portion. Therefore, the thick portion can be prevented from having an external shape which protrudes radially outward excessively. The flat face or the gently curved face can be used as a pressing face with which the locking fixture is pressed into the attachment hole of the vehicle body panel or as a seating face on which the electric wire protection member is arranged in the vehicle body panel.

According to the electric wire protection member according to one or more embodiments of the invention, it is possible to make the resin flow easily up to the terminal end during molding.

One or more embodiments of the invention has been described above briefly. Further, when a detailed description described below is read through with reference to the accompanying drawings, details of one or more embodiments of the invention can be made further clear.

### BRIEF DESCRIPTION OF THE DRAWINGS

FIG. 1 is a perspective view of an electric wire protection member according to an embodiment of the invention;

FIGS. 2A and 2B are a prospective view and a side view, respectively, of a locking fixture and a cylindrical coating member shown in FIG. 1;

FIGS. 3A and 3B are a front view and a plan view, respectively, of the locking fixture and the cylindrical coating member shown in FIG. 1;

FIG. 4 is a perspective view of an electric wire protection tube and a core;

FIG. 5 is a perspective view showing a mold opening state of a mold in which the electric wire protection tube and the core have been set in a lower mold part;

FIG. 6 is a perspective view showing a mold opening state of the mold after the electric wire protection member has been molded;

FIG. 7 is a perspective view of a micro molding machine;

FIG. 8 is a perspective view of an electric wire protection member according to a first modification of the embodiment;

FIG. 9 is a perspective view of an electric wire protection member according to a second modification of the embodiment; and

FIG. 10 is a perspective view of a locking fixture-including protection tube according to the background art.

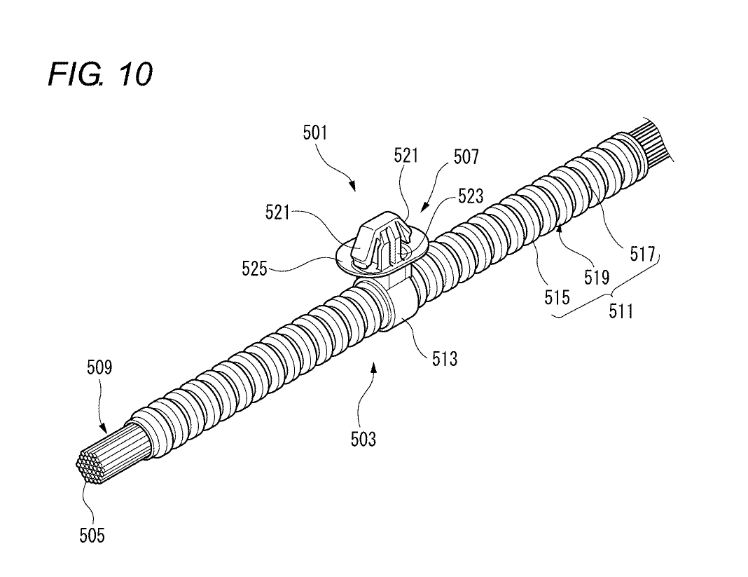

### DETAILED DESCRIPTION

An embodiment according to the invention will be described below with reference to the drawings.

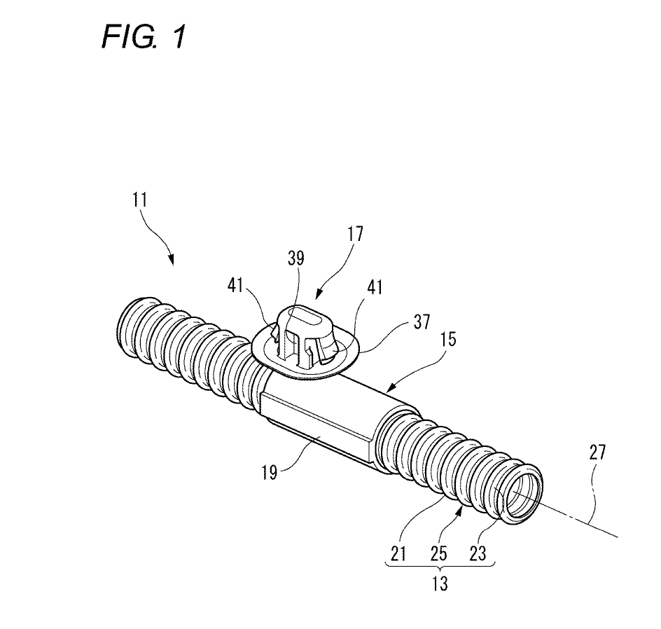

FIG. 1 is a perspective view of an electric wire protection member 11 according to an embodiment of the invention. The electric wire protection member 11 according to the embodiment of the invention has an electric wire protection tube 13, a cylindrical coating member 15, a locking fixture 17, and ribs 19.

The electric wire protection tube 13 is made of an insulating synthetic resin material to be flexible in material property and structure. The electric wire protection tube 13 is formed into a flexible bellows shape in such a manner that a plurality of large diameter portions 21 and a plurality of small diameter portions 23 are provided consecutively and alternately so that an outer circumferential groove 25 can be formed as a recess between every two of the large diameter portions adjacent to each other across the small diameter portion 23. That is, each of the large diameter portions 21 and the small diameter portions 23 can be elastically deformed in material property. Side wall portions of the outer circumferential grooves 25 formed among the large diameter portions 21 and the small diameter portions 23 are weak against a bending load so as to have flexibility also in structure. A so-called corrugated tube is preferably used as the electric wire protection tube 13. It is a matter of course that an elastic tube formed into a long circular cylindrical shape may be used as the electric wire protection tube according to the embodiment.

In addition, no slit for inserting electric wires (not shown) is formed in the electric wire protection tube 13 according to the embodiment. However, it is a matter of course that a slit may be formed over the entire length of the electric wire protection tube 13 in a direction along an axis 27.

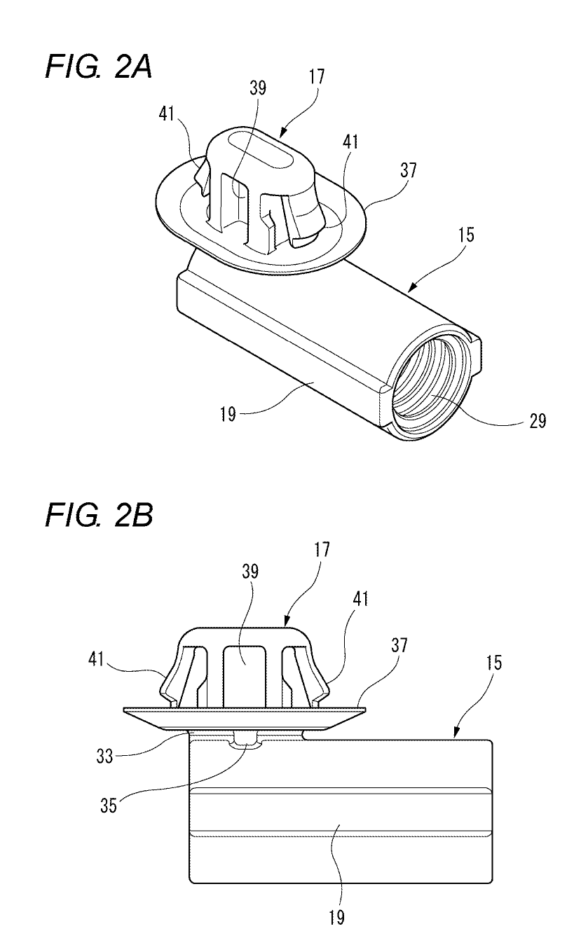

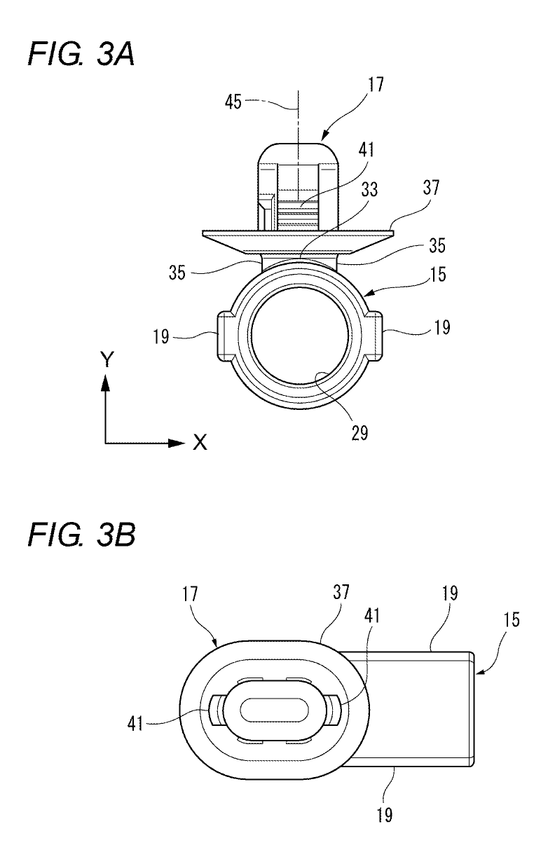

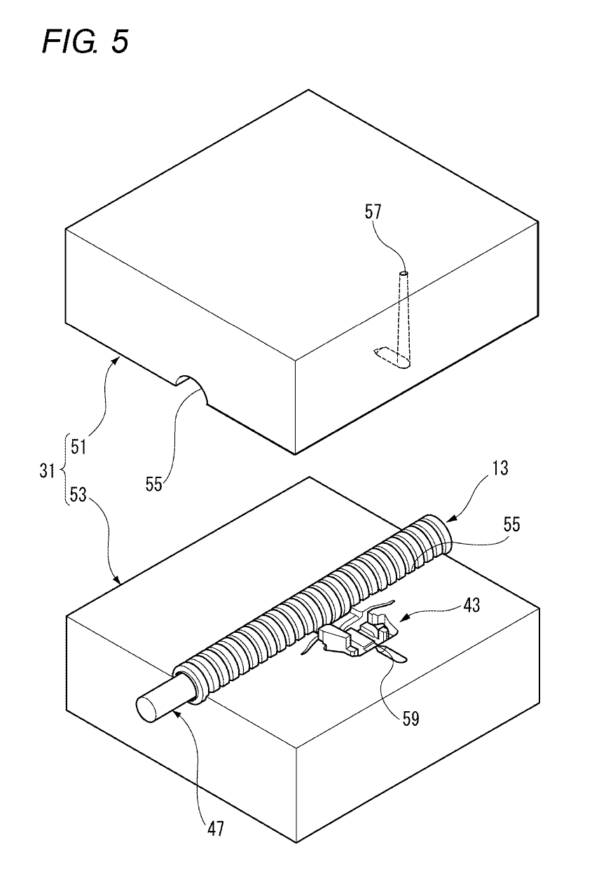

As shown in FIG. 2A to FIG. 3B, the cylindrical coating member 15 is made of an insulating synthetic resin material and molded on an outer circumferential surface of the electric wire protection tube 13. The outer circumferential grooves 25 are filled with an internal molding portion 29 (see FIG. 2A) so that the cylindrical coating member 15 can be integrated with the electric wire protection tube 13. In the embodiment, the cylindrical coating member 15 is molded on the outer circumferential surface of a desired portion of the electric wire protection tube 13 to cover the outer circumferential grooves 25 and the large diameter portions 21 adjacent thereto. The cylindrical coating member 15 is placed and molded in a mold 31 (see FIG. 5) together with the electric wire protection tube 13. The mold 31 will be described later. Incidentally, the cylindrical coating member 15 is molded to cover at least two large diameter portions 21. In addition, when a slit is formed in the electric wire protection tube 13, a slit may be also formed in the cylindrical coating member 15. Thus, the section of the cylindrical coating member 15 may have a C-shape to be open.

A connection portion 33 is integrally molded with the cylindrical coating member 15. The connection portion 33 protrudes on a radially outer side of the cylindrical coating member 15 and formed into an erect wall shape extending in the direction along the axis 27 of the electric wire protection tube 13. That is, the cylindrical coating member 15 is connected to the connection portion 33 at a slight distance in the circumferential direction. Reinforcement pieces 35 are provided to protrude vertically on opposite side surfaces of the connection portion 33. Lower ends of the reinforcement pieces 35 are firmly fixed to parts of an outer circumference of the cylindrical coating member 15.

The locking fixture 17 such as a clip is integrally molded with the connection portion 33 of the cylindrical coating member 15. In the embodiment, the locking fixture 17 includes an abutment plate 37, an axial portion 39, and a pair of locking claws 41. The abutment plate 37 abuts against a circumferential edge of an attachment hole made in a vehicle body panel (not shown). The axial portion 39 protrudes vertically from the abutment plate 37. The pair of locking claws 41 expand from a front end side of the axial portion 39 toward the abutment plate 37. In the locking fixture 17, the abutment plate 37 is integrally molded with an upper end of the connection portion 33.

In the locking fixture 17, the pair of locking crawls 41 are narrowed so that the axial portion 39 can be inserted into the attachment hole. When the abutment plate 37 abuts against the vehicle body panel, the pair of locking crawls 41 are opened on a back side of the vehicle body panel so that the vehicle body panel can be held between the locking crawls 41 and the abutment plate 37. In this manner, the locking fixture 17 is locked to the vehicle body panel.

The ribs 19 are formed in side surfaces of the cylindrical coating member 15. At least one rib 19 is formed to protrude from a side surface of the cylindrical coating member 15 and extend continuously in the direction along the axis 27. In the embodiment, the ribs 19 are formed as a pair of protrusive strips shaped like straight lines. In the embodiment, the sectional shape of each of the ribs 19 is formed as a rectangular shape perpendicular to the axis 27. Besides, the sectional shape of the rib 19 may be formed as another shape such as a triangle, a semicircle, a pentagon, a hexagon or an octagon. The rib 19 is molded by a groove (not shown) provided in an inner wall surface of a cavity 43 (see FIG. 5) of the mold 31. The groove serves for accelerating the flow of a resin to be injected into the cavity 43 during molding. When the sectional shape of the rib 19 is a quadrilateral shape, an aspect ratio of the rib 19 is preferably about 1:1 to 1:5.

When the aspect ratio is maintained, the area of the inner wall surface of the groove with which the resin makes contact during injection can be reduced. That is, interfacial friction of the molten resin against the inner wall surface of the groove can be reduced. Thus, excellent fluidity of the resin can be secured by the groove.

Incidentally, for example, horizontal and vertical directions of the aspect ratio may be set as a horizontal direction (X direction) and a vertical direction (Y direction) shown in FIG. 3A. However, the invention is not limited thereto. That is, the sectional shape of the rib 19 may have, for example, a rectangular shape long in the horizontal direction in FIG. 3A as long as almost the same aspect ratio as the above-described one can be maintained.

In the embodiment, in the electric wire protection member 11, a plurality of (two in the embodiment) ribs 19 are provided at circumferentially different positions. For example, the number of the plurality of ribs 19 may be two, three, four, etc. In the embodiment, two ribs 19 are provided. The two ribs 19 are disposed at equal intervals on the outer circumference of the cylindrical coating member 15 shaped like a circular cylinder. More specifically, the two ribs 19 are provided at two circumferential places where a plane including the axis 27 and perpendicular to an insertion/removal central line 45 of the locking fixture 17 (see FIG. 3A) intersects with the cylindrical coating member 15.

Incidentally, it is a matter of course that only one rib 19 may be formed in the electric wire protection member according to the invention.

Next, a method for manufacturing the electric wire protection member 11 will be described.

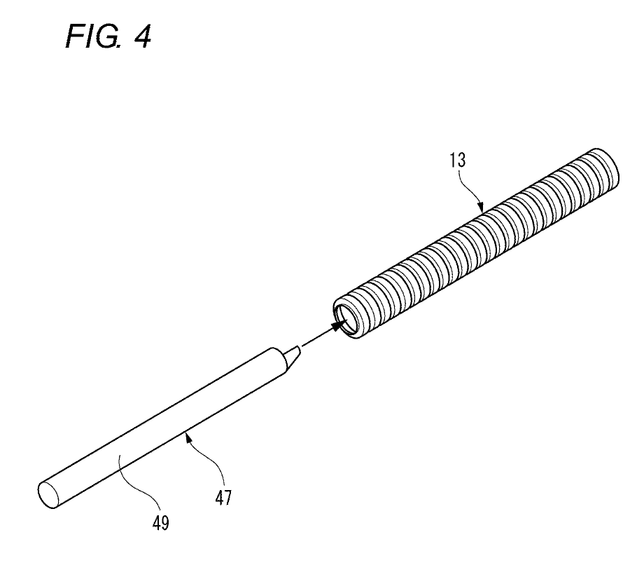

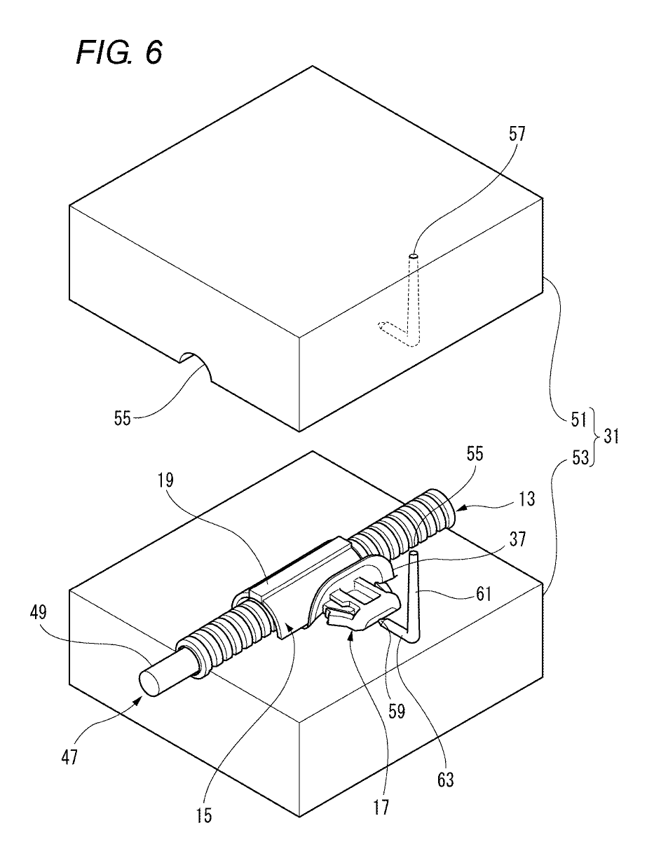

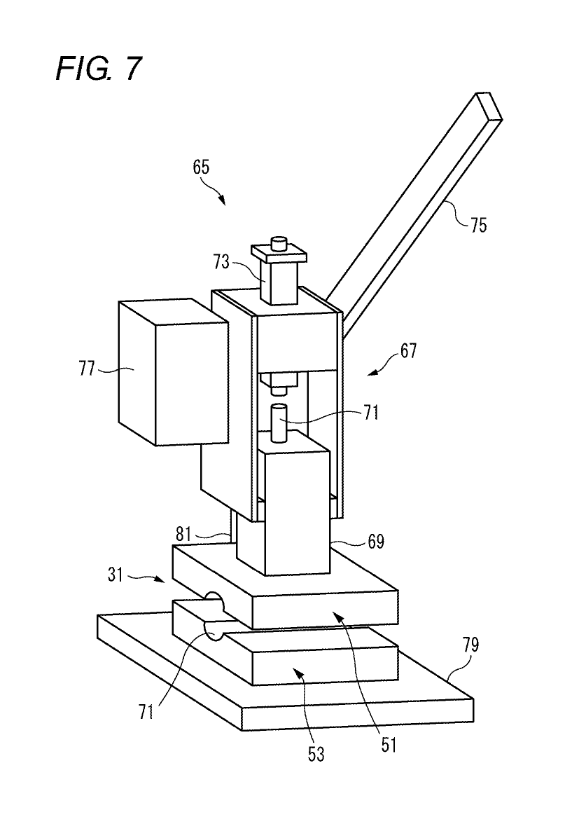

FIG. 4 is a perspective view of the electric wire protection tube and a core. FIG. 5 is a perspective view showing a mold opening state of the mold in which the electric wire protection tube and the core have been set in a lower mold part. FIG. 6 is a perspective view showing a mold opening state of the mold after the electric wire protection member has been molded. FIG. 7 is a perspective view of a micro molding machine.

As shown in FIG. 4, first, the core 47 is inserted into the electric wire protection tube 13 in order to mold the electric wire protection member 11.

The core 47 includes an axial body 49 which is approximately equal to an inner diameter of the electric wire protection tube 13 so as to be able to be inserted into the electric wire protection tube 13. The axial body 49 of the core 47 is inserted into the electric wire protection tube 13 before the electric wire protection tube 13 is set in the mold 31. Thus, the electric wire protection tube 13 can be prevented from being destroyed even by injection pressure of a molding resin which is high in temperature.

As shown in FIG. 5, the mold 31 includes an upper mold part 51 and a lower mold part 53 both of which are made of a synthetic resin. The electric wire protection tube 13 into which the core 47 has been inserted is placed in an electric wire protection tube reception portion 55 between the upper mold part 51 and the lower mold part 53. The upper mold part 51 and the lower mold part 53 are clamped by a mold clamping device to hold the electric wire protection tube 13 therebetween. Therefore, the cavity 43 corresponding to the cylindrical coating member 15, the connection portion 33 and the locking fixture 17 is disposed between the electric wire protection tube 13 disposed inside the mold 31 and an inner surface of the electric wire protection tube reception portion 55. In this state, a molten thermoplastic resin is injected with low pressure into the cavity 43 through a gate 59 from a supply passage 57 of the upper mold part 51. When a predetermined amount of the thermoplastic resin is supplied into the cavity 43, the cavity 43 is filled with the thermoplastic resin. When the thermoplastic resin is cured, the cylindrical coating member 15, the connection portion 33 and the locking fixture 17 which are externally shaped by the inner surface shape of the cavity 43 are molded on the outer circumference of the electric wire protection tube 13.

As shown in FIG. 6, a molded article is taken out from the opened upper mold part 51 and the lower mold part 53 of the mold 31 and a sprue 61 and a runner 63 are removed from the gate 59. In this manner, manufacturing of the electric wire protection member 11 is completed. Incidentally, although the embodiment has been described in the case where the gate 59 through which the thermoplastic resin is injected with low pressure into the cavity 43 is set in a front end of the locking fixture 17, the gate 59 may be set in a flat face of the cylindrical coating member 15.

A micro molding machine 65 shown in FIG. 7 is used for injection of the thermoplastic resin into the cavity 43 inside the mold. The micro molding machine 65 is a resin molding machine which can be operated by an operator alone without using external power such as an electric motor. The micro molding machine 65 includes the upper mold part 51, the mold clamping device (not shown) which opens/closes the lower mold part 53, and a low pressure injection device 67 which injects a molten resin into the mold 31 with pressure.

The low pressure injection device 67 has a heating cylinder 69, a plunger 71, an injection cylinder 73, a handle 75 and a temperature controller 77. A heater for heating and melting a synthetic resin such as a polypropylene resin etc. is provided in the heating cylinder 69. The plunger 71 injects the molten resin of the heating cylinder 69 from not-shown nozzles. The injection cylinder 73 moves the plunger 71 forward. The handle 75 drives the injection cylinder 73. The temperature controller 77 keeps heating temperature of the heating cylinder 69 at a desired temperature. The heating cylinder 69, the plunger 71, the injection cylinder 73, the handle 75 and the temperature controller 77 are supported by a support column 81 provided erectly on a pedestal 79.

Incidentally, the maximum amount of the resin which can be molded in one shot of injection molding by the micro molding machine 65 in the embodiment is about several tens of grams and the micro molding machine 65 can be operated manually by use of an air cylinder or a link etc. during mold clamping of the mold 31. Incidentally, the low pressure injection device 67 may drive the injection cylinder 73 by use of external power such as an electric motor, air, etc. More specifically, for example, injection molding devices disclosed in JP-A-2010-260297, JP-A-2012-30429, JP-A-2013-103492, etc. may be used as the micro molding machine 65.

The mold 31 according to the embodiment is disposed on the pedestal 79. The upper mold part 51 and the lower mold part 53 of the mold 31 are mated with each other to hold the electric wire protection tube 13 therebetween so that the electric wire protection tube 13 can be received in the electric wire protection tube reception portion 55. Thus, the cavity 43 serves as a cavity where molding can be performed. The molten thermoplastic resin is supplied from the supply passage 57 to the cavity through the sprue 61, the runner 63, and the gate 59 to thereby injection-mold the cylindrical coating member 15 on the outer circumference of the electric wire protection tube 13. Thus, the electric wire protection member 11 is formed.

Next, effects of the electric wire protection member 11 having the above-described configuration will be described.

In the electric wire protection member 11 according to the embodiment, the ribs 19 are provided on the side surfaces of the cylindrical coating member 15. The ribs 19 extend continuously along the axis 27 of the cylindrical coating member 15 and protrude from the side surfaces thereof. The cylindrical coating member 15 and the locking fixture 17 are molded by injecting the resin into the cavity 43 of the mold 31. On this occasion, the electric wire protection tube 13 is placed in the cavity 43. That is, the cylindrical coating member 15 is molded out of the resin flowing into a gap between the electric wire protection tube 13 and the cavity 43. The gap forms the thickness of the cylindrical coating member 15.

When a thin molded article is molded, the flow of the resin during injection is hindered by the gap which is narrow and long or by irregularities of the electric wire protection tube 13. Therefore, it is difficult to make the resin flow up to a terminal end of the molded article. On the other hand, in the electric wire protection member 11 according to the embodiment, the ribs 19 are provided on the side surfaces of the cylindrical coating member 15. Accordingly, grooves in directions thickening gaps are formed in the inner wall surfaces of the cavity 43 corresponding to portions where the ribs 19 should be molded. The grooves serve as passages in which the injected resin can flow satisfactorily. The resin flowing in the grooves reaches the opposite axial ends of the cylindrical coating member 15 immediately. In this state, the resin can easily reach the terminal end of the molded article from the grooves through the gaps having short circumferential distances.

In addition, due to the plurality of ribs 19 provided in the electric wire protection member 11 according to the embodiment, restriction of a bending direction of the cylindrical coating member 15 can be controlled. When, for example, three ribs 19 are disposed at equal intervals on the outer circumference of the cylindrical coating member 15 shaped like a circular cylinder, bending or vibration of the cylindrical coating member 15 in all directions can be restricted equally. When, for example, the pair of ribs 19 are disposed at equal intervals on the outer circumference of the cylindrical coating member 15 shaped like a circular cylinder, bending or vibration of the cylindrical coating member 15 in an in-plane direction including the pair of ribs 19 can be restricted.

Next, an electric wire protection member according to a first modification of the embodiment will be described.

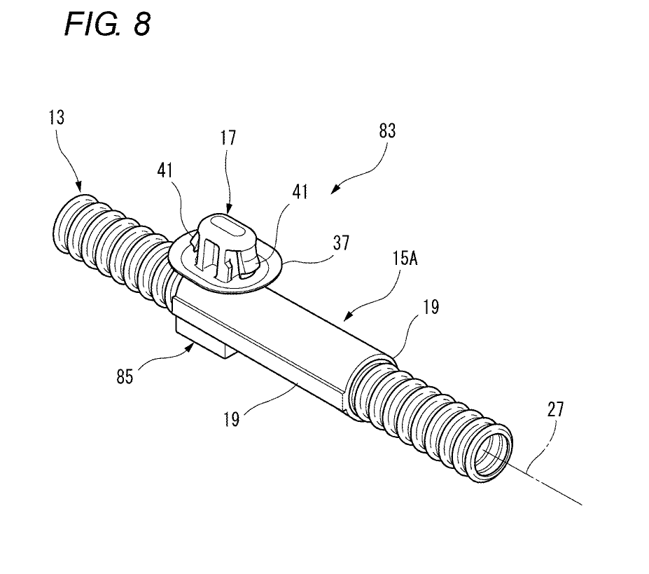

FIG. 8 is a perspective view of the electric wire protection member according to the first modification of the embodiment. Incidentally, the same constituents as those of the electric wire protection member 11 in each of the following modifications will be referred to by the same numerals respectively, and duplicate description thereof will be omitted.

An electric wire protection member 83 has a thick portion 85 provided on a cylindrical coating member 15A. The thick portion 85 has a flat face or a curved face. The thick portion 85 is molded to be radially thicker than, of any other circumferential portion of the cylindrical coating member 15A, at least an outer circumferential portion where a locking fixture 17 is provided protrusively. The flat face or the curved face is formed in an outer surface of the thick portion 85. The flat face or the curved face is formed as a flat face or a gently curved face substantially parallel with a plane passing through an axis 27 of an electric wire protection tube 13.

In the electric wire protection member 83, the cylindrical coating member 15A on which the thick portion 85 is provided is prevented from being easily destroyed in the radial direction because the thick portion 85 serves as a bearing wall. In addition, only the thick portion 85 provided on the cylindrical coating member 15A protrudes from an outer circumferential surface of the cylindrical coating member 15A more than any other outer circumferential portion. Therefore, enlargement of the cylindrical coating member 15A can be suppressed in comparison with the case where the cylindrical coating member 15A is made thick all over the circumference thereof. Further, the flat face or the gently curved face substantially parallel with the plane passing through the axis 27 of the electric wire protection tube 13 is formed in the outer surface of the thick portion 85. Therefore, the thick portion 85 can be prevented from having an external shape protruding outward in the radial direction excessively. The flat face or the gently curved face can be used as a pressing face with which the locking fixture 17 is pressed against an attachment hole of a vehicle body panel or as a seating face on which the electric wire protection member 83 is arranged in the vehicle body panel.

Next, an electric wire protection member according to a second modification of the embodiment will be described.

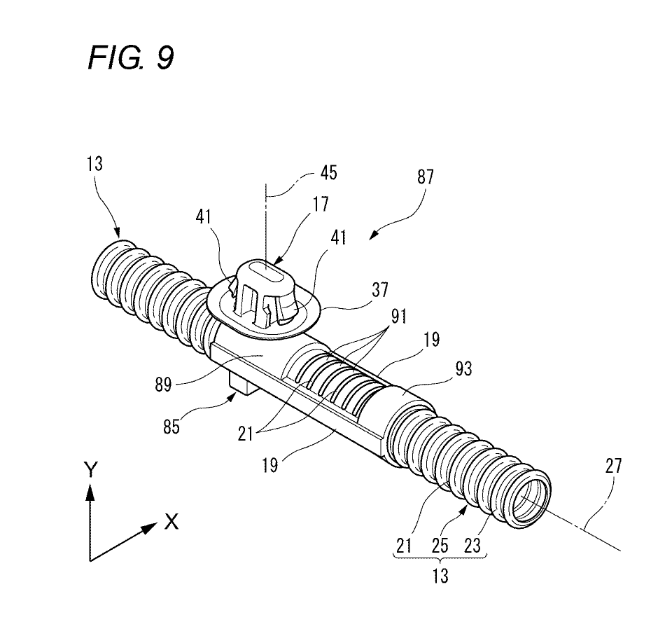

FIG. 9 is a perspective view of the electric wire protection member according to the second modification of the embodiment.

An electric wire protection member 87 has two ribs 19. In addition, the same thick portion 85 as the above-described one is also provided on the electric wire protection member 87. Incidentally, the thick portion 85 may be removed from the electric wire protection member 87.

A cylindrical coating member 89 of the electric wire protection member 87 has a plurality of annular portions 91 which are molded on at least parts of a plurality of outer circumferential grooves 25 of an electric wire protection tube 13 in an outer circumferential direction. The plurality of annular portions 91 are connected by a pair of ribs 19. The pair of ribs 19 are provided at two circumferential places where a plane including an axis 27 of the electric wire protection tube 13 and perpendicular to an insertion/removal central line 45 of a locking fixture 17 intersects with the cylindrical coating member 89.

One longitudinal end sides of the pair of ribs 19 are connected to each other by a pressing portion 93. The pressing portion 93 is molded on at least parts of the plurality of outer circumferential grooves 25 in the outer circumferential direction. In the embodiment, the pressing portion 93 is provided in an upper half part of the cylindrical coating member 89 in the outer circumferential direction, as shown in FIG. 9. Incidentally, the pressing portion 93 may be formed in a lower half part of the cylindrical coating member 89 or in both the upper and lower half parts. In this manner, of the electric wire protection tube 13, a part at a predetermined distance from the cylindrical coating member 89 can be supported on the cylindrical coating member 89 by the pressing portion 93 with the pair of ribs 19 serving as arm portions. Thus, a plurality of annular portions 91 disposed between the pressing portion 93 and the cylindrical coating member 89 form cut-off portions.

In the electric wire protection member 87, the plurality of annular portions 91 are molded and firmly fixed respectively to the plurality of outer circumferential grooves 25 of the electric wire protection tube 13. While circumferential parts of the annular portions 91 are connected by the ribs 19, the annular portions 91 are mostly separated from one another in the circumferential direction. Thus, a usage amount of a resin can be reduced.

In addition, in the electric wire protection member 87, the electric wire protection tube 13 is fixed by the pressing portion 93 formed in front ends of the pair of ribs 19. As described above, the pair of ribs 19 are provided at two circumferential places in which a plane including the axis 27 and perpendicular to the insertion/removal central line 45 intersects with the cylindrical coating member 89. Vertical vibration of the electric wire protection tube 13 in a direction along an insertion/removal direction of the locking fixture 17 is restricted by the ribs 19. The electric wire protection tube 13 is fixed by the electric wire protection member 87. In addition, horizontal vibration of the electric wire protection tube 13 in a direction perpendicular to the insertion/removal direction of the locking fixture 17 is restricted by the pressing portion 93. Incidentally, for example, the vertical and horizontal directions can be set, for example, as a vertical direction (Y direction) and a horizontal direction (X direction) shown in FIG. 9.

Thus, according to the electric wire protection member 87, vibration propagating from the electric wire protection tube 13 on sides where the ribs 19 are extended can be restricted.

Accordingly, according to the electric wire protection member 11, the electric wire protection member 83 and the electric wire protection member 87 according to the embodiment, the resin can be made to flow easily up to the terminal end during molding.

Here, the features of the electric wire protection members according to the embodiment of the invention will be summarized briefly as follows.

1. An electric wire protection member (11, 83, 87) including:

a cylindrical electric wire protection tube (13) which has flexibility;

a cylindrical coating member (15, 15A, 89) which is molded on an outer circumference surface of the electric wire protection tube (13); and

a locking fixture (17) which is integrally molded with the cylindrical coating member (15, 15A, 89) and locked to an attachment hole of a vehicle body panel,

wherein at least one rib (19) is formed in a side surface of the cylindrical coating member (15, 15A, 89) to protrude from the side surface and to extend continuously in a direction along an axis (27) of the cylindrical coating member (15, 15A, 89).

2. The electric wire protection member (11, 83, 87) according to the configuration 1,

wherein a plurality of ribs (19) are provided at circumferentially different positions in the cylindrical coating member.

3. The electric wire protection member (87) according to the configuration 1 or 2,

wherein the electric wire protection tube (13) includes a plurality of large diameter portions (21) and a plurality of small diameter portions (23) provided consecutively and alternately such that an outer circumferential groove is formed as a recess between every two of the large diameter portions (21) adjacent to each other across the small diameter portion (23), and

wherein the cylindrical coating member (89) includes a plurality of annular portions (91) which are molded on at least a part of the outer circumferential grooves in an outer circumferential direction and which are connected by the rib (19).

4.The electric wire protection member (83, 87) according to any one of the configurations 1-3,

wherein the cylindrical coating member (15A, 89) includes a thick portion (85) and a flat or gently curved face,

wherein the thick portion (85) is molded to be radially thicker than, of any other circumferential portion of the cylindrical coating member (15A, 89), at least an outer circumferential portion where the locking fixture (17) is provided to protrude, and

wherein the flat or gently curved face is formed in an outer surface of the thick portion (85) to be substantially parallel with a plane passing through an axis of the electric wire protection tube.

Incidentally, the invention is not limited to the above-described embodiment but any modification, improvement, etc. can be made thereon suitably. In addition thereto, the materials, the shapes, the dimensions, the numbers, the arrangement places etc. of the respective constituent elements in the above-described embodiment are not limited but can be set desirably as long as the invention can be achieved.

What is claimed is:

1. An electric wire protection member comprising:
a cylindrical electric wire protection tube which has flexibility;
a cylindrical coating member which is molded on an outer circumference surface of the electric wire protection tube; and
a locking fixture which is integrally molded with the cylindrical coating member and locked to an attachment hole of a vehicle body panel,
wherein at least one rib is formed in a side surface of the cylindrical coating member to protrude from the side surface and to extend continuously in a direction along an axis of the cylindrical coating member.

2. The electric wire protection member according to claim 1,
wherein a plurality of ribs are provided at circumferentially different positions in the cylindrical coating member.

3. The electric wire protection member according to claim 1,
wherein the electric wire protection tube comprises a plurality of large diameter portions and a plurality of small diameter portions provided consecutively and alternately such that an outer circumferential groove is formed as a recess between every two of the large diameter portions adjacent to each other across the small diameter portion, and
wherein the cylindrical coating member comprises a plurality of annular portions which are molded on at least a part of the outer circumferential grooves in an outer circumferential direction and which are connected by the rib.

4. The electric wire protection member according to claim 1,
wherein the cylindrical coating member comprises a thick portion and a flat or gently curved face,
wherein the thick portion is molded to be radially thicker than, of any other circumferential portion of the cylindrical coating member, at least an outer circumferential portion where the locking fixture is provided to protrude, and vwherein the flat or gently curved face is formed in an outer surface of the thick portion to be substantially parallel with a plane passing through an axis of the electric wire protection tube.
